(19) United States
(12) Patent Application Publication
(10) Pub. No.: US 2026/0034612 A1
(43) Pub. Date: Feb. 5, 2026

(54) SYSTEM AND METHOD FOR MANAGING REPLACEMENT OF PROTECTIVE GLASS PANEL OF LASER PROCESSING DEVICE AND LASER PROCESSING DEVICE

(71) Applicant: SK On Co., Ltd., Seoul (KR)

(72) Inventors: Hyeong Won KIM, Daejeon (KR); Oh San AN, Daejeon (KR)

(21) Appl. No.: 19/211,297

(22) Filed: May 19, 2025

(30) Foreign Application Priority Data
Aug. 2, 2024 (KR) 10-2024-0102967

(51) Int. Cl. B23K 26/70; B23K 26/03; B23K 26/06

(52) U.S. Cl. CPC B23K 26/706; B23K 26/032; B23K 26/0648

(57) ABSTRACT

A system for managing replacement of a protective glass panel of a laser processing device includes a laser processing device including a lens portion focusing a laser beam on a point, a protective glass panel disposed between the lens portion and the point, a camera configured to acquire an image of the protective glass panel, and a controller configured to analyze clarity of the image and generate information on whether to replace the protective glass panel based on the analyzed clarity.

### CROSS-REFERENCE TO RELATED APPLICATION(S)

This patent document claims the priority and benefits of Korean Patent Application No. 10-2024-0102967 filed on Aug. 2, 2024, the disclosure of which is incorporated herein by reference in its entirety.

### TECHNICAL FIELD

The disclosure and implementations disclosed in this patent document generally relate to a system and method for managing replacement of a protective glass panel of a laser processing device and a laser processing device.

### BACKGROUND

A laser processing device may locally process (e.g., welding, notching, micro-patterning, cutting, heat treatment, etc.) a processing target by focusing a laser beam on a point of the processing target through a lens. Spatter and plasma fume occurring during laser processing of the laser processing device may adversely affect the performance of the lens, and thus, protective glass panel may be disposed between the lens and the processing target to protect the lens.

### SUMMARY

Spatter and plasma fumes occurring during laser processing (e.g., welding, notching, micro-patterning, cutting, heat treatment, etc.) of the laser processing device may gradually contaminate the protective glass panel. As the protective glass panel becomes more contaminated, a laser beam output of the laser processing device may gradually decrease. As the laser beam output of the laser processing device decreases, the possibility of a processing defect occurring may increase. Therefore, if the protective glass panel is replaced so that a contamination level of the protective glass panel does not become too high, occurrence of a processing defect due to contamination of the protective glass panel may be prevented.

The present disclosure may be implemented in some embodiments to provide a system and method for managing replacement of a protective glass panel of a laser processing device capable of efficiently determining the replacement time of the protective glass panel and efficiently preventing occurrence of a processing defect due to contamination of the protective glass panel and provide a laser processing device having a structure advantageous in improving the efficiency of monitoring the status of the protective glass panel.

In some embodiments of the present disclosure, a system for managing replacement of a protective glass panel of a laser processing device includes: a laser processing device including a lens portion focusing a laser beam on a point; a protective glass panel disposed between the lens portion and the point; a camera configured to acquire an image of the protective glass panel; and a controller configured to analyze clarity of the image and generate information on whether to replace the protective glass panel based on the analyzed clarity.

The clarity may include a modulation transfer function (MTF).

The controller may generate information on replacement of the protective glass panel when the MTF of the image is less than a reference value, and generate information on unnecessary replacement of the protective glass panel when the MTF of the image is equal to or greater than the reference value.

The controller may store correlation information between a laser beam output of the laser processing device and the MTF of the image, receive processing defect occurrence minimum output information, and determine the reference value based on the processing defect occurrence minimum output information and the correlation information.

The controller may generate the information on whether to replace the protective glass panel based on clarity of an entire region of the image.

The laser processing device may be configured to move the laser beam along a laser beam path to which the point belongs, and the camera may be configured to acquire an image of a region corresponding to the laser beam path in the protective glass panel.

The camera may acquire the image excluding a region outside the region corresponding to the laser beam path in the protective glass panel.

The camera may sequentially acquire a plurality of images along a region corresponding to the laser beam path in the protective glass panel, and the controller may analyze clarity of the plurality of images and generate information on whether to replace the protective glass panel based on the analyzed clarity.

The laser processing device may further include: a laser provider providing the laser beam; and a scanner providing a transmission path of the laser beam between the lens portion and the laser provider.

The camera may acquire the image through an image acquisition path overlapping a portion of the transmission path of the scanner.

The laser processing device may further include: a first reflective portion disposed in a transmission path of the laser beam and the image acquisition path; a second reflective portion disposed between the first reflective portion and the laser provider in the transmission path of the laser beam; and a third reflective portion disposed between the first reflective portion and the camera in the image acquisition path.

The laser processing device may be a laser welding device configured to weld the point.

In some embodiments of the present disclosure, a laser processing device includes: a laser provider providing a laser beam; a lens portion focusing the laser beam to a point; a protective glass panel disposed between the lens portion and the point; a scanner providing a transmission path of the laser beam between the lens portion and the laser provider; and a camera acquiring an image of the protective glass panel through an image acquisition path overlapping a portion of the transmission path of the scanner.

The laser processing device may further include: a first reflective portion disposed in a transmission path of the laser beam and the image acquisition path; a second reflective portion disposed between the first reflective portion and the laser provider in the transmission path of the laser beam; and a third reflective portion disposed between the first reflective portion and the camera in the image acquisition path.

The protective glass panel may include a region corresponding to a laser beam path to which the point belongs and an outer region, and the camera may sequentially acquire a plurality of images along the region corresponding to the laser beam path in the protective glass panel.

In some embodiments of the present disclosure, a method for managing replacement of a protective glass panel of a laser processing device including a lens portion focusing a laser beam onto a point in a laser beam path and configured to move the laser beam along the laser beam path includes: acquiring an image along the laser beam path; analyzing clarity of the image; and generating information on whether to replace the protective glass panel based on the analyzed clarity.

The clarity may include a modulation transfer function (MTF), and the generating may include generating information on replacement of the protective glass panel when the MTF of the image is less than a reference value and generating information on unnecessary replacement of the protective glass panel when the MTF of the image is equal to or greater than the reference value.

The generating may include generating the information on whether to replace the protective glass panel based on clarity of an entire region of the image.

The acquiring may include sequentially acquiring a plurality of images along a region corresponding to the laser beam path in the protective glass panel, and the analyzing may include analyzing clarity of the plurality of images.

The laser processing device may be a laser welding device configured to weld the point.

### BRIEF DESCRIPTION OF DRAWINGS

Certain aspects, features, and advantages of the present disclosure are illustrated by the following detailed description with reference to the accompanying drawings.

FIG. 1A is a diagram illustrating a system and method for managing replacement of a protective glass panel of a laser processing device according to an embodiment of the present disclosure and that protective glass panel of the laser processing device includes a contamination point in a region corresponding to a laser beam path.

FIG. 1B is a diagram illustrating a system and method for managing replacement of a protective glass panel of a laser processing device according to an embodiment of the present disclosure and that the protective glass panel of the laser processing device does not include a contamination point in a region corresponding to a laser beam path.

FIG. 2A is a diagram illustrating a system and method for managing replacement of a protective glass panel of a laser processing device according to an embodiment of the present disclosure and an image acquisition path of the laser processing device.

FIG. 2B is a diagram illustrating a system and method for managing replacement of a protective glass panel of a laser processing device according to an embodiment of the present disclosure and a laser beam transmission path of the laser processing device.

FIG. 3 is a graph illustrating a system and method for managing replacement of a protective glass panel of a laser processing device according to an embodiment of the present disclosure and a modulation transfer function of image 1 not including a contamination point and a modulation transfer function of image 2 including a contamination point of the laser processing device.

FIG. 4 is a graph illustrating a system and method for managing replacement of a protective glass panel of a laser processing device according to an embodiment of the present disclosure and correlation information between a laser beam output of the laser processing device and a modulation transfer function.

FIGS. 5 and 6 are flowcharts illustrating a method for managing replacement of a protective glass panel of a laser processing device according to an embodiment of the present disclosure.

### DETAILED DESCRIPTION

Prior to the description of the present disclosure, terms and words used in the present specification and claims to be described below should not be construed as limited to ordinary or dictionary terms, and should be construed in accordance with the technical idea of the present disclosure based on the principle that the inventors may properly define their own inventions in terms of terms in order to best explain the invention. Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

Also, the same reference numerals or symbols respectively illustrated in the attached drawings denote parts or elements that perform the actually same functions. For convenience of description and understanding, the parts or elements will be described by using the same reference numerals or symbols even in different embodiments. In other words, although elements having the same reference numerals are all illustrated in a plurality of drawings, the plurality of drawings do not mean an embodiment.

As used herein, the singular forms are intended to include the plural forms as well, unless the context clearly indicates otherwise. It will be further understood that the terms “comprises,” “comprising,” etc. when used in this specification, specify the presence of stated features, integers, steps, operations, elements, and/or components, but do not preclude the presence or addition of one or more other features, integers, steps, operations, elements, components, and/or groups thereof.

In addition, in the present specification, the expressions, such as an upper side, a lower side, a side face, a rear surface, and the like, are described based on the drawings and may be expressed differently when the direction of the corresponding object is changed.

The terms including ordinal numbers, such as ‘first’, ‘second’, etc. may be used herein to distinguish elements from one another. These ordinal numbers are merely used to distinguish the same or similar elements from one another, and meanings of the terms are not construed as being limited by the using of the ordinal numbers. For example, use orders or arrangement orders of elements combined with these ordinal numbers are not limited by numbers thereof. The ordinal numbers may be replaced with one another.

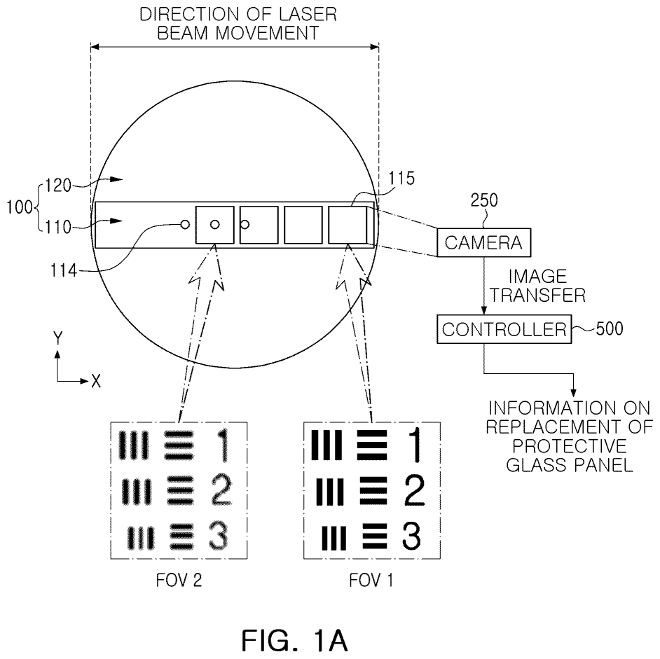

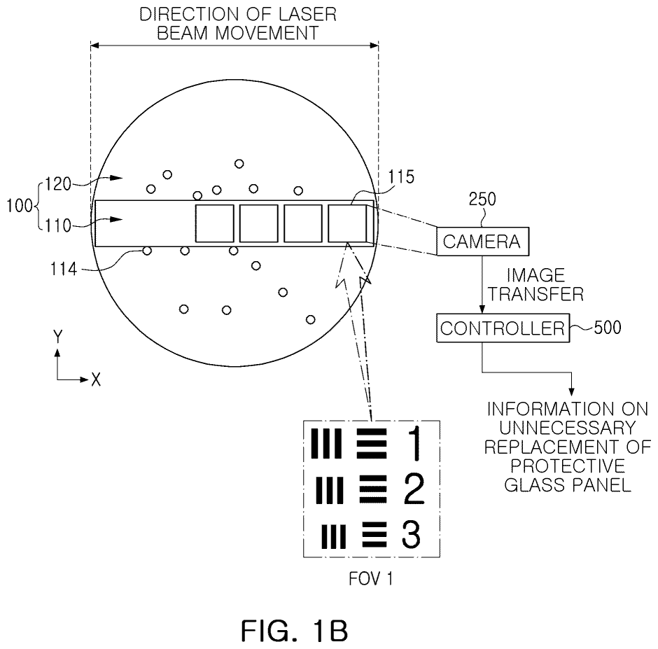

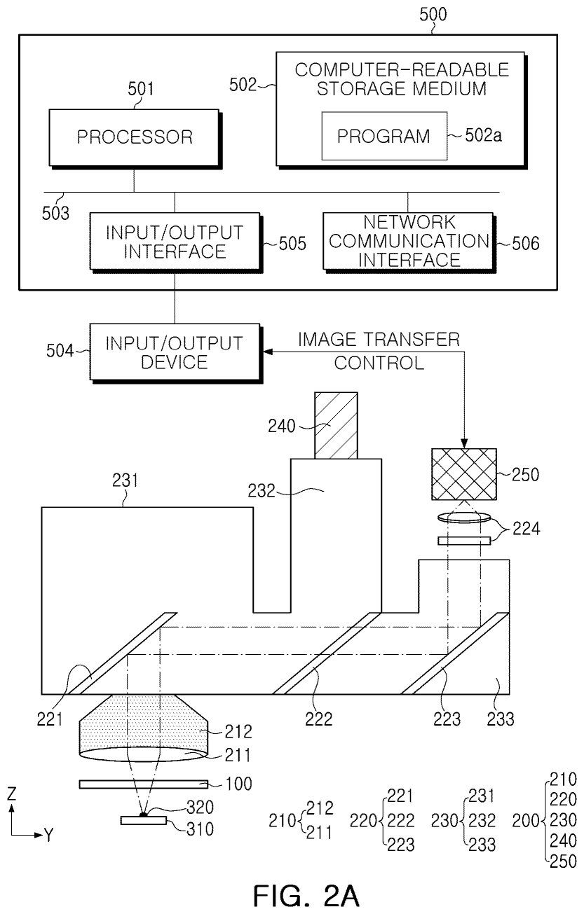

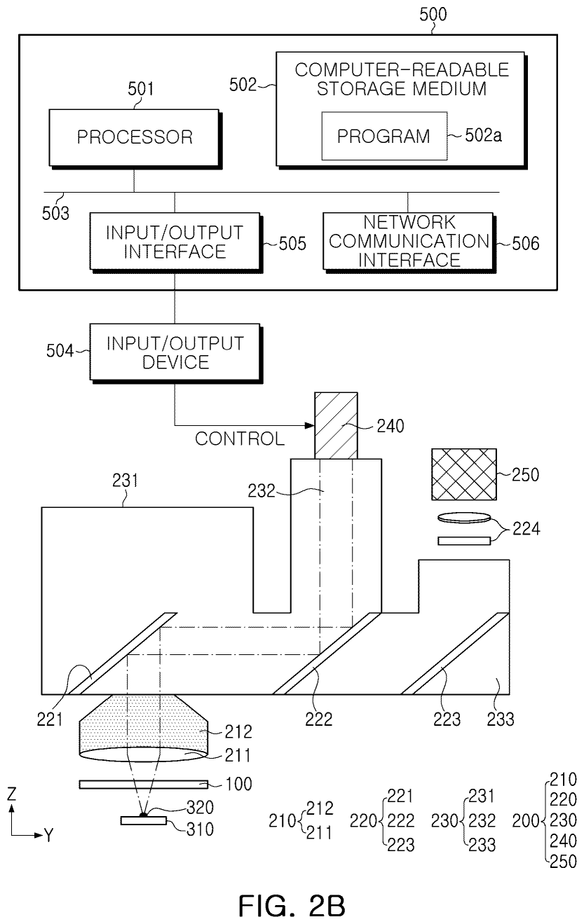

FIGS. 1A and 1B are enlarged views of a protective glass panel 100 of FIG. 2A and FIG. 2B from a Z-direction perspective. Referring to FIGS. 1A, 1B, 2A, and 2B, a system for managing replacement of a protective glass panel of a laser processing device according to an embodiment of the present disclosure may include a laser processing device 200, a protective glass panel 100, a camera 250, and a controller 500.

The laser processing device 200 may include a lens portion 210 that focuses a laser beam on a point 320 of a laser beam path 110. The point 320 may be a point on a surface of a processing target 310 and may be processed (e.g., welding, notching, micro-patterning, cutting, heat treatment, etc.) by the laser beam focused by the lens portion 210. For example, the laser processing device 200 may be a laser welding device configured to weld the point 320. For example, the processing target 310 may include battery cells and a busbar, may include a lower case and an upper cover of a module housing in which a battery module (including battery cells) is accommodated, or may include a plurality of electrodes and electrode tabs included in a battery cell, and may further include a low melting point metal material, such as solder, which may be locally melted by a laser beam.

The lens portion 210 may include a lens 211 and a support member 212. For example, the lens 211 may be implemented as an F-Theta lens and may be implemented based on lens parameters (e.g., focal length, etc.) designed to focus a laser beam on the point 320. For example, the support member 212 may support (e.g., accommodate or surround) the lens 211 to protect the lens 211 from external impacts and may maintain the lens parameters of the lens 211.

The protective glass panel 100 may be disposed between the lens portion 210 and the point 320. For example, the protective glass panel 100 may be disposed adjacent to the lens 211 to protect the lens 211 of the lens portion 210 and may have a surface shape (e.g., circular shape) corresponding to a surface shape (e.g., circular shape) of the lens 211. The protective glass panel 100 may block spatter and plasma fume occurring as the point 320 is processed from heading to the lens 211, thereby preventing the spatter and plasma fume from deteriorating the performance of the lens 211.

Here, spatter and plasma fume may gradually accumulate on the protective glass panel 100 as a plurality of contamination points 114, and the protective glass panel 100 may gradually become contaminated. As the protective glass panel 100 becomes contaminated, the laser beam output of the laser processing device 200 may gradually decrease. As the laser beam output of the laser processing device 200 decreases, the possibility of a processing defect occurring at the point 320 may increase. Therefore, if the protective glass panel 100 is replaced so that the contamination level does not become too high, the occurrence of a processing defect occurring at the point 320 due to contamination of the protective glass panel 100 may be prevented.

The camera 250 may be configured to acquire an image 115 of the protective glass panel 100. The camera 250 may transmit the image 115 to the controller 500 (e.g., wireless communication, wired communication, etc.). For example, the camera 250 may include an image sensor and/or a lens driver.

The controller 500 may be configured to analyze the clarity of the image 115 and generate information on whether to replace the protective glass panel based on the analyzed clarity. As the overall contamination level of the image 115 (e.g., the total number or total area of contamination points 114 within the image 115) increases, the clarity of the image 115 may decrease. Even if the controller 500 does not analyze a specific distribution, number, and area of contamination points 114 within the image 115, the controller 500 may efficiently determine the overall contamination level of the image 115 acquisition region of the protective glass panel 100 through the clarity of the image 115, efficiently determine a replacement timing of the protective glass panel 100, and efficiently prevent the occurrence of processing defects at the point 320 due to contamination of the protective glass panel 100.

Referring to FIG. 1A, image 1 FOV1 may be a relatively clear image because the contamination point 114 is not included in the image 115, and image 2 FOV2 may be a relatively blurry image because the contamination point 114 is included in the image 115. The controller 500 may analyze the clarity of image 1 FOV1 and the clarity of image 2 FOV2 and may generate a high clarity value of image 1 FOV1 and a low clarity value of image 2 FOV2. Since at least one (the low clarity value of image 2) of the clarity values of image 1 FOV1 and image 2 FOV2 may be less than a reference value, the controller 500 may generate information on replacement of the protective glass panel.

Referring to FIG. 1B, image 1 FOV1 may be a relatively clear image since the contamination point 114 is not included in the image 115. The controller 500 may generate a high clarity value of image 1 FOV1 by analyzing the clarity of image 1 FOV1. Since the clarity values of all images (high clarity value of image 1) may be greater than or equal to the reference value, the controller 500 may generate information on unnecessary replacement of the protective glass panel.

For example, the controller 500 may visually and/or audibly output the information on replacement of the protective glass panel as an alarm to notify a user of the laser processing device 200. For example, the controller 500 may remotely transmit the information on replacement of the protective glass panel and/or the information on unnecessary replacement of the protective glass panel to a terminal of the user of the laser processing device 200. For example, the controller 500 may transmit the information on replacement of the protective glass panel and/or the information on unnecessary replacement of the protective glass panel to a manufacturing execution system (MES) and/or a programmable logic controller (PLC). For example, the MES may control a processing process of the processing target 310 of the laser processing device 200 through the PLC and may control temporary suspension of the processing process of the laser processing device 200 according to the information on replacement of the protective glass panel. The protective glass panel 100 may be replaced during the temporary suspension.

For example, the controller 500 may generate the information on whether to replace the protective glass panel based on the clarity of the entire region of the image 115. Therefore, the influence (e.g., deviation) of the distribution of the contamination point 114 within the image 115 on the clarity of the image 115 may be reduced, and thus the reliability of the clarity analysis by the controller 500 may be improved.

The laser processing device 200 may be configured to move the laser beam along the laser beam path 110 (e.g., move in the X-direction). For example, the support member 212 may receive driving force by an actuator (not shown) of the laser processing device 200 to move a position of the point 320 in the X-direction, and a posture and/or position of the lens 211 may be controlled through the driving force. Alternatively, the actuator may drive a scanner 230 of the laser processing device 200 (e.g., rotate the scanner 230 on an X-Y plane), and the scanner 230 may control the posture and/or position of the lens portion 210, thereby moving the position of the point 320 in the X-direction.

The camera 250 may be configured to acquire the image 115 of a region corresponding to the laser beam path 110 on the protective glass panel 100. For example, the laser beam path of the laser processing device 200 and a specific image acquisition range of the camera 250 may overlap each other, and thus, a specific image acquisition position of the camera 250 on the protective glass panel 100 may also move when the actuator of the laser processing device 200 drives the scanner 230 or the lens portion 210. Alternatively, the specific image acquisition position of the camera 250 may move when a lens driver of the camera 250 controls the lens position and/or posture of the camera 250 or the actuator of the laser processing device 200 controls the position and/or posture of a tube lens 224.

The protective glass panel 100 may include a region corresponding to the laser beam path 110 to which the point 320 belongs and an outer region 120, and the camera 250 may acquire the image 115 by excluding the outer region 120 of the region corresponding to the laser beam path 110 in the protective glass panel 100. Since the contamination point 114 of the outer region 120 may not substantially affect the laser beam output of the laser processing device 200, the controller 500 may generate information on whether to replace the protective glass panel without substantially considering a contamination level of the outer region 120.

The camera 250 may sequentially acquire a plurality of images 115 along the region corresponding to the laser beam path 110 in the protective glass panel 100. At least a portion of each of the plurality of images 115 may not overlap each other. For example, the camera 250 may alternately perform an operation of acquiring one of the plurality of images 115 and an operation of moving a specific image acquisition position of the camera 250.

The controller 500 may analyze the clarity of the plurality of images 115 and generate information on whether to replace the protective glass panel based on the analyzed clarity. For example, the controller 500 may generate a clarity value of each of the plurality of images 115 and compare the lowest clarity value among the clarity values of the plurality of images 115 with the reference value or compare an average value of the clarity values of the plurality of images 115 with the reference value. The controller 500 may generate information on replacement of the protective glass panel or information on unnecessary replacement of the protective glass panel based on a comparison result.

Referring to FIGS. 2A and 2B, the laser processing device 200 according to an embodiment of the present disclosure may include a laser provider 240, the lens portion 210, the scanner 230, and the camera 250. Depending on the design, the camera 250 may not be included in the laser processing device 200 or may be implemented separately from the laser processing device 200 and included in the system for managing replacement of a protective glass panel of a laser processing device.

The laser provider 240 may provide a laser beam, the lens portion 210 may focus the laser beam on the point 320, the scanner 230 may provide a transmission path (the alternated long and short dash line in FIG. 2B) of the laser beam between the lens portion 210 and the laser provider 240, and the camera 250 may acquire an image of the protective glass panel 100 through an image acquisition path (the alternated long and short dash line in FIG. 2A) overlapping a portion of the transmission path (the alternated long and short dash line in FIG. 2B) of the laser beam of the scanner 230. Accordingly, the laser processing device 200 may efficiently form the image acquisition path (the alternated long and short dash line in FIG. 2A) of the camera 250 for acquiring an image of the protective glass panel 100, and the movement efficiency of the laser beam transmission path (the alternated long and short dash line in FIG. 2B) and the image acquisition path (the alternated long and short dash line in FIG. 2A) in the X-direction may also be improved. Accordingly, the efficiency of monitoring the status of the protective glass panel 100 may also be improved. At least partially overlapping paths may be defined as coaxial paths, and the camera 250 acquiring an image through the coaxial paths may be defined as a coaxial camera.

For example, the laser provider 240 may be implemented as an optical fiber to emit a laser beam (i.e., light energy) For example, the scanner 230 may include a scanner portion 231, a laser path tube 232, and an image path tube 233. The scanner portion 231 may provide a portion of the transmission path (the alternated long and short dash line in FIG. 2B) of the laser beam and a portion of the image acquisition path (the alternated long and short dash line in FIG. 2A), may overlap the lens portion 210 in a Z-direction, and may accommodate a first reflective portion 221. The laser path tube 232 may provide another portion of the transmission path (the alternated long and short dash line in FIG. 2B) of the laser beam, may overlap the laser provider 240 in the Z-direction, and may accommodate a second reflective portion 222. The image path tube 233 may provide another portion of the image acquisition path (the alternated long and short dash line in FIG. 2A), may overlap the camera 250 in the Z-direction, and may accommodate a third reflective portion 223.

Referring to FIGS. 2A and 2B, the laser processing device 200 according to an embodiment of the present disclosure may further include a plurality of reflective portions 220 and/or a tube lens 224, and the plurality of reflective portions 220 may include a first reflective portion 221, a second reflective portion 222, and a third reflective portion 223.

The first reflective portion 221 may be disposed in the transmission path (the alternated long and short dash line in FIG. 2B) of the laser beam and the image acquisition path (the alternated long and short dash line in FIG. 2A). The second reflective portion 222 may be disposed between the first reflective portion 221 and the laser provider 240 in the transmission path (the alternated long and short dash line in FIG. 2B) of the laser beam. The third reflective portion 223 may be disposed between the first reflective portion 221 and the camera 250 in the image acquisition path (the alternated long and short dash line in FIG. 2A). For example, each of the first, second, and third reflective portions 221, 222, and 223 may be implemented as a laser mirror and may be disposed obliquely with respect to the incident laser beam and/or light, thereby reflecting the laser beam and/or light in a designed reflection direction. For example, the second reflective portion 222 may be shifted in the X-direction to be disposed not to block the image acquisition path (the alternated long and short dash line in FIG. 2A) or may be implemented to allow light to pass therethrough and reflect the laser beam.

The tube lens 224 may be disposed between the third reflective portion 223 and the camera 250 and may be implemented based on lens parameters designed to determine an acquisition image size of the camera 250.

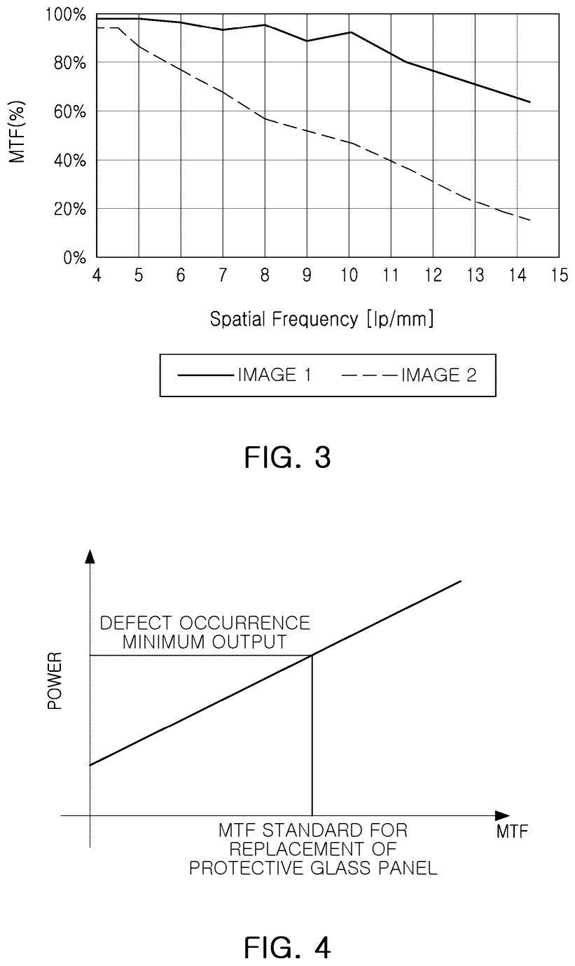

Referring to FIGS. 1A and 3, image 1 FOV1 not including the contamination point 114 is clear, and a modulation transfer function (MTF) of image 1 FOV1 may be relatively high. Image 2 FOV2 including the contamination point 114 is blurry, and an MTF of image 2 FOV2 may be relatively low. The clarity analyzed by the controller 500 may include the MTF.

The MTF may correspond to a value obtained by dividing the sum of the maximum brightness and the minimum brightness by a difference between the maximum brightness and the minimum brightness at a specific spatial frequency of the image 115, may be analyzed for each of a plurality of spatial frequencies, and may include contrast values analyzed for each of the plurality of spatial frequencies.

The controller 500 may generate information on replacement of the protective glass panel when the MTF of the image 115 is less than a reference value, and may generate information on unnecessary replacement of the protective glass panel when the MTF of the image 115 is greater than or equal to the reference value. For example, the controller 500 may compare the MTF at one selected from among a plurality of spatial frequencies of the image 115 with the reference value or compare an average value of the MTF at each of the plurality of spatial frequencies of the image 115 with the reference value, and generate the information on replacement of the protective glass panel or information on unnecessary replacement of the protective glass panel based on a comparison result.

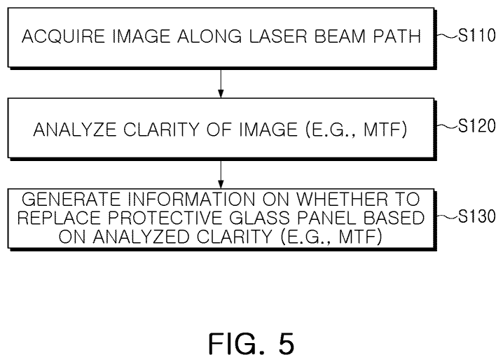

Referring to FIGS. 1A and 4, the controller 500 mat store correlation information between the laser beam output of the laser processing device and the MTF of the image 115, receive processing defect occurrence minimum output information, and determine the reference value (the MTF standard for replacement of the protective glass panel in FIG. 4) based on the processing defect occurrence minimum output information and the correlation information. For example, the correlation may include slopes and positions (e.g., an average value, a center value, etc.) of the values in FIG. 4 and may include data in the form of a mathematical formula, and the controller 500 may receive the correlation information before processing.

For example, the defect occurrence minimum output information may vary depending on the type and model of the processing target 310, and a possibility of occurrence of processing defects at the point 320 of the processing target 310 may be determined as the laser beam output of the laser processing device corresponding to a specific probability. The controller 500 may input the defect occurrence minimum output information into one of a plurality of variables of the correlation information, thereby determining the reference value (the MTF standard for replacement of the protective glass panel in FIG. 4), which is another of the plurality of variables of the correlation information.

Referring to FIGS. 1A, 2A, and 5, a method for managing replacement of a protective glass panel of a laser processing device according to an embodiment of the present disclosure may be executed by the controller 500 and may include, as a method for managing replacement of the protective glass panel 100 of the laser processing device 200 including the lens portion 210 focusing a laser beam on one point 320 of the laser beam path 110 and configured to move the laser beam along the laser beam path 110, includes acquiring the image 115 along the laser beam path 110 (S110), analyzing clarity (e.g., MTF) of the image (S120), and generating information on whether to replace the protective glass panel based on the analyzed clarity (e.g., MTF) (S130). Accordingly, even without analyzing a specific distribution, number, and area of the contamination points 114 in the image 115, the controller 500 may efficiently determine the overall contamination level of the image 115 acquisition region in the protective glass panel 100 through the clarity (e.g., MTF) of the image 115, efficiently determine a timing for replacing the protective glass panel 100, and efficiently prevent the occurrence of processing defects at the point 320 due to contamination of the protective glass panel 100.

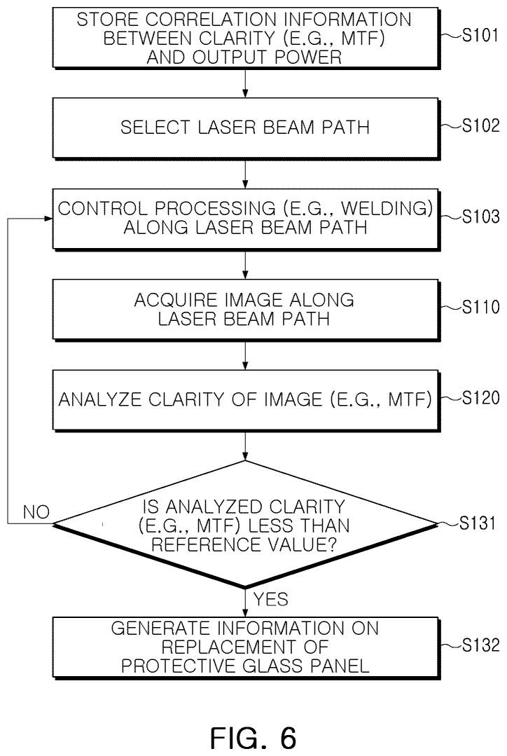

Referring to FIGS. 1A, 2A, and 6, the generating (S130 of FIG. 5) may include generating information on replacement of the protective glass panel when the MTF of the image 115 is less than the reference value (e.g., the MTF standard for replacement of the protective glass panel of FIG. 4), and generating information on unnecessary replacement of the protective glass panel when the MTF of the image 115 is greater than or equal to the reference value (e.g., the MTF standard for replacement of the protective glass panel of FIG. 4).

Referring to FIGS. 1A, 2A, and 6, the method for managing replacement of a protective glass panel of a laser processing device according to an embodiment of the present disclosure may be executed by the controller 500 and may further include at least one of storing correlation information (e.g., the graph of FIG. 4) between the laser beam output of the laser processing device 200 and the MTF of the image 115 (S101), selecting the laser beam path 110 (S102), and controlling processing along the laser beam path 110 (S103). For example, the controller 500 may select a laser beam path selected according to the type and model of the processing target 310 among a plurality of different laser beam paths.

Meanwhile, referring to FIGS. 2A and 2B, the controller 500 may be implemented as a computing device including at least one processor 501, a computer-readable storage medium 502, and a communication bus 503. The communication bus 503 may interconnect various other components of the controller 500, including the processor 501 and the computer-readable storage medium 502.

The processor 501 may cause the controller 500 to operate according to the embodiments mentioned above. For example, the processor 501 may execute one or more programs stored in the computer-readable storage medium 502. The one or more programs may include one or more computer-executable instructions, and the computer-executable instructions may be configured to cause, when executed by the processor 501, the controller 500 to perform operations according to the embodiments.

The computer-readable storage medium 502 may be configured to store computer-executable instructions or program code, program data, and/or other suitable forms of information. A program 502a stored on the computer-readable storage medium 502 includes a set of instructions executable by the processor 501. In an embodiment, the computer-readable storage medium 502 may be memory (volatile memory, such as random access memory, nonvolatile memory, or a suitable combination thereof), one or more magnetic disk storage devices, optical disk storage devices, flash memory devices, or any other form of storage medium that may be accessed by the controller 500 and capable of storing desired information, or a suitable combination thereof.

The controller 500 may also include one or more input/output interfaces 505 providing an interface for one or more input/output devices 504 and one or more network communication interfaces 506. The input/output interfaces 505 and the network communication interfaces 506 are connected to the communication bus 503. The network may be one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), 5G, Wi-Fi, or another cellular network, and may also be implemented as Ethernet, Media Oriented Systems Transport (MOST), Flexray, Controller region Network (CAN), Local Interconnect Network (LIN), Internet, Bluetooth, Near Field Communication (NFC), Zigbee, Radio Frequency (RF), etc.

The input/output device 504 may be connected to other components of the controller 500 via the input/output interface 505. The input/output devices 504 may include, for example, input devices, such as pointing devices (such as a mouse or trackpad), keyboards, touch input devices (such as a touchpad or a touchscreen), voice or sound input devices, various types of sensor devices and/or image capturing devices, and/or output devices, such as display devices, printers, speakers, and/or network cards. For example, the input/output devices 504 may be included inside the controller 500 as a component constituting the controller 500 or may be connected to the controller 500 as a separate device distinct from the controller 500.

Meanwhile, the embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

The system and method for managing replacement of a protective glass panel of a laser processing device according to an embodiment of the present disclosure may efficiently prevent the occurrence of processing defects due to contamination of the protective glass panel by efficiently determining the replacement time of the protective glass panel and, and the laser processing device according to an embodiment of the present disclosure may have a structure advantageous in improving the efficiency of monitoring the status of the protective glass panel.

Only specific examples of implementations of certain embodiments are described. Variations, improvements and enhancements of the disclosed embodiments and other embodiments may be made based on the disclosure of this patent document.

What is claimed is:

1. A system for managing replacement of a protective glass panel of a laser processing device, the system comprising:
a laser processing device including a lens portion focusing a laser beam on a point;
a protective glass panel disposed between the lens portion and the point;
a camera configured to acquire an image of the protective glass panel; and
a controller configured to analyze clarity of the image and generate information on whether to replace the protective glass panel based on the analyzed clarity.

2. The system of claim 1, wherein the clarity includes a modulation transfer function (MTF).

3. The system of claim 2, wherein the controller generates information on replacement of the protective glass panel when the MTF of the image is less than a reference value, and generates information on unnecessary replacement of the protective glass panel when the MTF of the image is equal to or greater than the reference value.

4. The system of claim 3, wherein the controller stores correlation information between a laser beam output of the laser processing device and the MTF of the image, receives processing defect occurrence minimum output information, and determines the reference value based on the processing defect occurrence minimum output information and the correlation information.

5. The system of claim 1, wherein the controller generates the information on whether to replace the protective glass panel based on clarity of an entire region of the image.

6. The system of claim 1, wherein the laser processing device is configured to move the laser beam along a laser beam path to which the point belongs, and
the camera is configured to acquire an image of a region corresponding to the laser beam path in the protective glass panel.

7. The system of claim 6, wherein the camera acquires the image excluding a region outside the region corresponding to the laser beam path in the protective glass panel.

8. The system of claim 6, wherein the camera sequentially acquires a plurality of images along a region corresponding to the laser beam path in the protective glass panel, and
the controller analyzes clarity of the plurality of images and generates information on whether to replace the protective glass panel based on the analyzed clarity.

9. The system of claim 1, wherein
the laser processing device further includes:
a laser provider providing the laser beam; and
a scanner providing a transmission path of the laser beam between the lens portion and the laser provider.

10. The system of claim 9, wherein the camera acquires the image through an image acquisition path overlapping a portion of the transmission path of the scanner.

11. The system of claim 10, wherein
the laser processing device further includes:
a first reflective portion disposed in the transmission path and the image acquisition path;
a second reflective portion disposed between the first reflective portion and the laser provider in the transmission path; and
a third reflective portion disposed between the first reflective portion and the camera in the image acquisition path.

12. The system of claim 1, wherein the laser processing device is a laser welding device configured to weld the point.

13. A laser processing device comprising:
a laser provider providing a laser beam;
a lens portion focusing the laser beam to a point;
a protective glass panel disposed between the lens portion and the point;
a scanner providing a transmission path of the laser beam between the lens portion and the laser provider; and
a camera acquiring an image of the protective glass panel through an image acquisition path overlapping a portion of the transmission path of the scanner.

14. The laser processing device of claim 13, further comprising:
a first reflective portion disposed in the transmission path and the image acquisition path;
a second reflective portion disposed between the first reflective portion and the laser provider in the transmission path; and
a third reflective portion disposed between the first reflective portion and the camera in the image acquisition path.

15. The laser processing device of claim 13, wherein the protective glass panel includes a region corresponding to a laser beam path to which the point belongs and an outer region, and
the camera sequentially acquires a plurality of images along the region corresponding to the laser beam path in the protective glass panel.

16. A method for managing replacement of a protective glass panel of a laser processing device including a lens portion focusing a laser beam onto a point in a laser beam path and configured to move the laser beam along the laser beam path, the method comprising:
acquiring an image along the laser beam path;
analyzing clarity of the image; and
generating information on whether to replace the protective glass panel based on the analyzed clarity.

17. The method of claim 16, wherein the clarity includes a modulation transfer function (MTF), and
the generating includes generating information on replacement of the protective glass panel when the MTF of the image is less than a reference value and generating information on unnecessary replacement of the protective glass panel when the MTF of the image is equal to or greater than the reference value.

18. The method of claim 16, wherein the generating includes generating the information on whether to replace the protective glass panel based on clarity of an entire region of the image.

19. The method of claim 16, wherein the acquiring includes sequentially acquiring a plurality of images along a region corresponding to the laser beam path in the protective glass panel, and
the analyzing includes analyzing clarity of the plurality of images.

20. The method of claim 16, wherein the laser processing device is a laser welding device configured to weld the point.
